(19) United States
(12) Patent Application Publication
(10) Pub. No.: US 2016/0070410 A1
(43) Pub. Date: Mar. 10, 2016

(54) DISPLAY APPARATUS, ELECTRONIC APPARATUS, HAND-WEARING APPARATUS AND CONTROL SYSTEM

(71) Applicant: Cho-Yi LIN, New Taipei City (TW)

(72) Inventors: Cho-Yi LIN, New Taipei (TW); Yu-Hao Chang, Taipei (TW)

(21) Appl. No.: 14/941,874

(22) Filed: Nov. 16, 2015

Related U.S. Application Data
(63) Continuation-in-part of application No. 14/660,005, filed on Mar. 17, 2015.
Application No. 14/660,005 is a continuation of application No. 13/465,403, filed on May 7, 2012, now Pat. No. 9,012,828.

(30) Foreign Application Priority Data
May 9, 2011 (TW) 100116225
Jul. 31, 2015 (TW) 104125025

(51) Int. Cl. G06F 3/041; G06F 3/0482; G06F 3/0481; G06F 3/042; G06F 3/0488

(52) U.S. Cl. CPC G06F 3/0416; G06F 3/0412; G06F 3/0421; G06F 3/04883; G06F 3/04817; G06F 3/0482; G06F 2203/04104; G06F 2203/04808

(57) ABSTRACT

The present application provides a display apparatus, an electronic apparatus, a hand-wearing apparatus and a control system. The display apparatus comprises a panel for displaying a control pattern, a frame disposed on outside of the panel, an optical sensing module disposed at the frame, a control circuit coupled with the optical sensing module to perform a function corresponding to a location the object obtained from the sensing module, and a switch coupled with the control circuit to display the control pattern on the panel and activate the optical sensing module to sense the object while being turned on.

### FIELD OF THE INVENTION

The present invention relates to a field of touch control technique, and more particularly to a display apparatus, electronic apparatus, hand-wearing apparatus and control system.

### BACKGROUND OF THE INVENTION

In order to prevent an electronic apparatus from being un-operational because its remote controller is broken or lost, a set of operation buttons is reserved on the electronic apparatus even though the electronic apparatus has been equipped with a corresponding remote controller. However, when there are not enough operation buttons on the electronic apparatus, it might take more operation time (such as selecting a channel on a television) or need more complicated operation method (such as selecting a function from a multi-level menu) to perform a specific operation. Or, in another aspect, when there are too many operation buttons on the electronic apparatus, an area reserved for the operation buttons and manufacturing cost would be increased. Therefore, it is a topic to be solved that how an adequate amount of operation buttons can be reserved on the electronic apparatus.

### SUMMARY OF THE INVENTION

The present invention provides a display apparatus, an electronic apparatus, a hand-wearing apparatus and a control system which provides an adequate amount of operation buttons thereon according to different requirement.

One embodiment of the present invention provides a display apparatus comprising a panel to display a control pattern, wherein the control pattern comprises a plurality of function icons, and a function input of the display apparatus corresponds to an icon combination formed by selecting at least one of the function icons in a specific sequence; a frame disposed on outside of the panel; an optical sensing module disposed at the frame, wherein the optical sensing module defines a touch control area, detects a location of an object in the touch control area, and comprises an image sensing module for defining the touch control area, retrieving at least one image which comprises the object, and obtaining at least one image feature of the object according to the at least one image, wherein the touch control area covers the control pattern, and a calculation module coupled with the image sensing module to calculate the location of the object according to the at least one image feature; a control circuit coupled with the optical sensing module and the panel, and executing the function input corresponding to the icon combination while determining, according to the location of the object, that the function icons selected by the object forms the icon combination; and a switch coupled with the control circuit to display the control pattern on the panel and activate the optical sensing module to sense the object while being turned on.

In other aspect, one embodiment of the present invention provides a display apparatus comprising a panel to display an input area; a frame disposed on outside of the panel; an optical sensing module disposed at the frame, wherein the optical sensing module defines a touch control area, detects a moving trace of an object in the touch control area, and comprises an image sensing module for defining the touch control area, retrieving at least one image which comprises the object, and obtaining at least one image feature of the object according to the at least one image, wherein the touch control area covers the input area, and a calculation module coupled with the image sensing module to calculate the moving trace of the object according to the at least one image feature; a control circuit coupled with the optical sensing module and the panel, and executing a function input corresponding to the moving trace; and a switch coupled with the control circuit to display the input area on the panel while being turned on.

In other aspect, the present invention provides an electronic apparatus comprising a surface; a touched object attached onto the surface, wherein the touched object is a carrier with a specific pattern and is corresponding to at least one function input of the electronic apparatus; an optical sensing module disposed on the surface, wherein the optical sensing module defines a touch control area, detects a position information of an object in the touch control area, and comprises an image sensing module for defining the touch control area, retrieving at least one image which comprises the object, and obtaining at least one image feature of the object according to the at least one image, wherein the touch control area covers the carrier, and a calculation module coupled with the image sensing module to calculate the position information of the object according to the at least one image feature; and a control circuit coupled with the optical sensing module, and executing one of the at least one function input, which corresponds to the position information, to control the electronic apparatus.

In other aspect, the present invention provides a hand-wearing apparatus comprising a case; an optical sensing module disposed at the case, wherein the optical sensing module defines a touch control area, detects a position information of an object in the touch control area, and comprises an image sensing module for defining the touch control area, retrieving at least one image which comprises the object, and obtaining at least one image feature of the object according to the at least one image, wherein the touch control area covers the carrier, and a calculation module coupled with the image sensing module to calculate the position information of the object according to the at least one image feature; and a control circuit coupled with the optical sensing module, and executing one of the at least one function input, which corresponds to the position information, to control the hand-wearing apparatus.

In other aspect, the present invention provides a control system comprising a control apparatus disposed on a surface and a controlled apparatus being independent from the control apparatus. The control apparatus comprises a touched object corresponding to at least one function input of the control apparatus; an optical sensing module disposed on the surface, wherein the optical sensing module defines a touch control area, detects a position information of an object in the touch control area, and comprises an image sensing module for defining the touch control area, and obtaining an image feature of the object, wherein the touch control area covers the carrier, and a calculation module coupled with the image sensing module to calculate the position information of the object according to the image feature; a control circuit coupled with the optical sensing module, wherein the control circuit generates an operation signal corresponding to the position information while determining, according to the position information, that the object touches the touched object; and a first signal interface coupled with the control circuit to receive the operation signal. The controlled apparatus comprises a second signal interface coupled with the first signal interface to receive the operation signal from the first signal interface and performs an operation corresponding to the operation signal.

The present invention does not require physical buttons because an optical sensing method is applied to detect a position touching object. In addition, a space reserved for optical sensing and a layout of a plurality of virtual buttons are not limited due to the hardware size. Accordingly, more buttons can be provided for an apparatus with a specific surface such that a more convenient operation for a user can be achieved.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a display apparatus according to the first embodiment of the present invention.

FIG. 2 is a schematic diagram showing another electrical connection between the switch, the control circuit and the optical sensing module according to the first embodiment of the present invention.

FIG. 3A is a schematic diagram showing a first position at the frame where the optical sensing module is disposed according to the first embodiment of the present invention.

FIG. 3B is a schematic diagram showing a second position at the frame where the optical sensing module is disposed according to the first embodiment of the present invention.

FIG. 3C is a schematic diagram showing a third position at the frame where the optical sensing module is disposed according to the first embodiment of the present invention.

FIG. 4A is a circuit block diagram of an optical sensing module used in the first embodiment according to one embodiment of the present invention.

FIG. 4B is a schematic diagram of another display apparatus according to the first embodiment of the present invention.

FIG. 5 is a schematic diagram of an image sensing module used in the first embodiment according to one embodiment of the present invention.

FIG. 6 is a schematic diagram of a front view of the image sensing module used in the first embodiment according to one embodiment of the present invention.

FIG. 7 is a cross-sectional diagram along line A-A′ of the image sensor shown in FIG. 6.

FIG. 8 is an illustration of a method for calculating a position of the object via the calculation module according to one embodiment of the present invention.

FIG. 9 is a schematic diagram of an image data of the image sensor according to one embodiment of the present invention.

FIG. 10 is a schematic diagram of a display apparatus according to the second embodiment of the present invention.

FIG. 11A is a schematic diagram of an electronic apparatus according to the third embodiment of the present invention.

FIG. 11B is a schematic diagram of one variation of the electronic apparatus according to the third embodiment of the present invention.

FIG. 11C is a schematic diagram of one variation of the electronic apparatus according to the third embodiment of the present invention.

FIG. 11D is a schematic diagram of one variation of the electronic apparatus according to the third embodiment of the present invention.

FIG. 11E is a schematic diagram of one variation of the electronic apparatus according to the third embodiment of the present invention.

FIG. 11F is a schematic diagram of another electronic apparatus according to the third embodiment of the present invention.

FIG. 11G is a schematic diagram of another electronic apparatus according to the third embodiment of the present invention.

FIG. 12A is a schematic diagram of an electronic apparatus according to the fourth embodiment of the present invention.

FIG. 12B is a schematic diagram of another electronic apparatus according to the fourth embodiment of the present invention.

FIG. 12C is a schematic diagram of another electronic apparatus according to the fourth embodiment of the present invention.

FIG. 12D is a schematic diagram of another electronic apparatus according to the fourth embodiment of the present invention.

FIG. 12E is a schematic diagram of another electronic apparatus according to the fourth embodiment of the present invention.

FIG. 12F is a schematic diagram of another electronic apparatus according to the fourth embodiment of the present invention.

FIG. 13A is a schematic diagram of a hand-wearing apparatus according to the fifth embodiment of the present invention.

FIG. 13B is a schematic diagram of another hand-wearing apparatus according to the fifth embodiment of the present invention.

FIG. 14 is a circuit block diagram of a control system according to the sixth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed. In this application, the term “couple” represents that a signal can be transmitted between two elements through wired or wireless transmission interface, that is, the two elements could be connected directly, through a wired transmission interface, or through a wireless transmission interface so that the two elements are not physically connected.

### First Embodiment

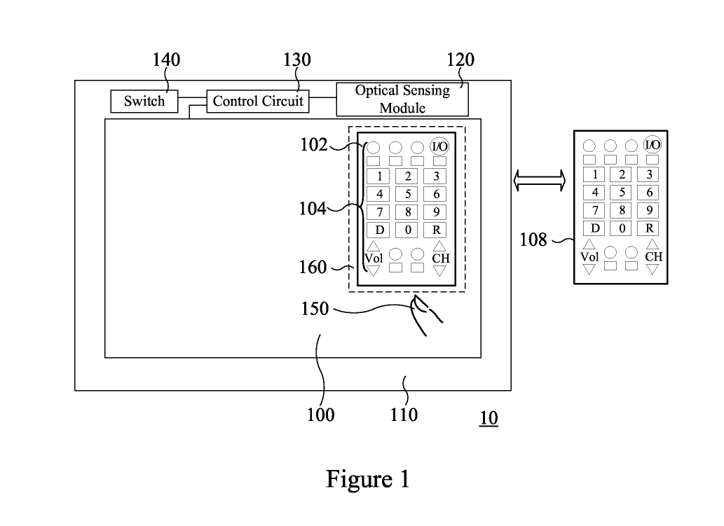

Refer to FIG. 1, which is a schematic diagram of a display apparatus according to the first embodiment of the present invention. The display apparatus 10 could be an electronic device such as a digital television or a computer display panel, which displays an image or could be an electronic apparatus with a panel, such as an intercom or a mobile phone. In the embodiment, the display apparatus 10 comprises a panel 100, a frame 110, an optical sensing module 120, a control circuit 130 and a switch 140. The panel 100 could be used to display a control pattern 102, which comprises a plurality of function icons 104, wherein the control pattern 102 and a content of the function icons 104 could correspond to the control buttons of the remote controller 108. At least one function input of the display apparatus 10 could be mapped to one of the function icons 104 or mapped to a specific sequence of some of the function icons 104. That is, it could be that one of the function icons corresponds to one function input, one of the function icons corresponds to a plurality of function inputs, some of the function icons correspond to a plurality of function inputs, or some of the function icons correspond to one function input. The function input comprises but is not limited to the function of volume control, channel selection, panel adjustment, video input selection or numeric input. For ease of description, one function icon 104 or a specific sequence of some function icons 104 is termed as an icon combination.

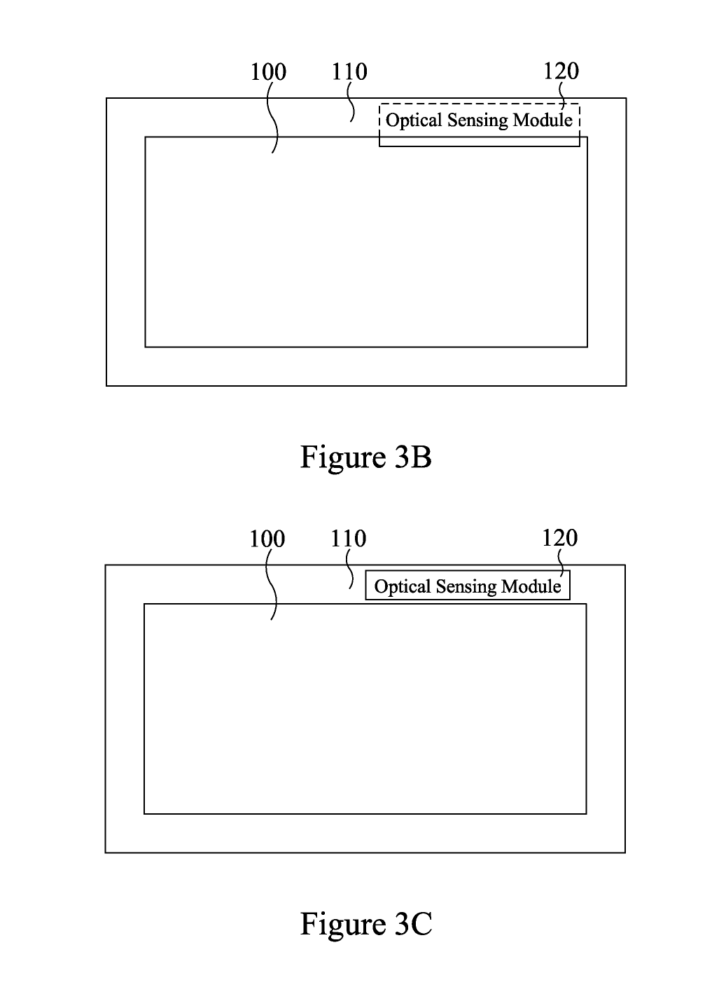

As shown in FIG. 1, the frame 110 is disposed on the outside of the panel 100, the optical sensing module 120 is disposed at the frame 110, and a sensing area of the optical sensing module 120 covers the touch control area 160. Specifically, the optical sensing module 120 could be embedded in the frame 110 (as shown in FIG. 3A), disposed on the frame 110 (as shown in FIG. 3C), or a part of the optical sensing module 120 is in the frame 120 and rest part of the optical sensing module 120 protrudes from the frame 120 (as shown in FIG. 3B). The control circuit 130 is coupled with the optical sensing module 120 and the panel 100 to receive a sensing signal generated from the optical sensing module 120 and control the panel 100 to display control pattern 102 by using OSD (On Screen Display) technology. The switch 140 is coupled with the control circuit 130 so that, while the switch 140 is turned on, the signal emitted from the switch 140 could make the control circuit 130 display the control pattern 102 on the panel 100 and activate the optical sensing module 120 for performing operations to sense the object 150. Furthermore, besides being coupled with the control circuit 130 as showing in FIG. 1, the switch 140 could be coupled with the optical sensing module 120 and the control circuit 130 at the same time to directly activate the optical sensing module 120.

It is noted that, although the frame 10 surrounds the four sides of the panel 100 in this embodiment, the frame 110 could be only at one side, two sides or multiple sides of the panel 100. Furthermore, an USB (Universal Serial Bus), SPI (Serial Peripheral Interface) bus, UART (Universal Asynchronous Receiver/Transmitter) bus, I2C (Inter-Integrated Circuit) bus or any other signal transmission interface can be used to transmit signals between the optical sensing module 120 and the control circuit 130.

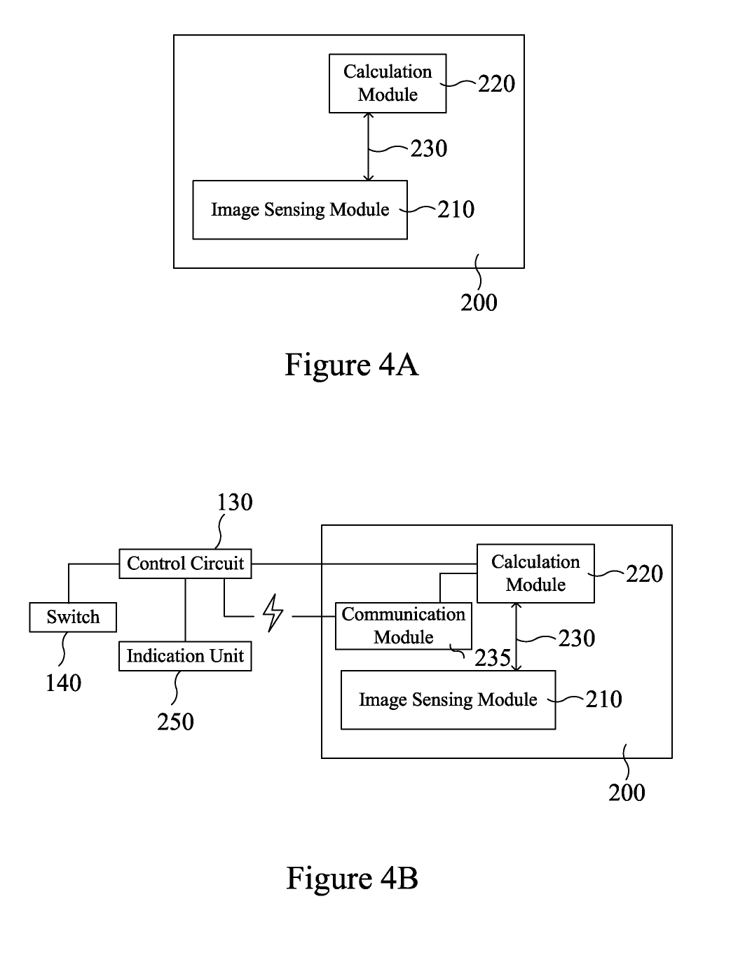

Refer to FIG. 4A, which is a circuit block diagram of an optical sensing module used in the first embodiment according to one embodiment of the present invention. In the embodiment, the optical sensing module 200 is applied as the optical sensing module 120 described above. The optical sensing module 200 comprises an image sensing module 210 and a calculation module 220, and the signals are transmitted between the image sensing module 210 and the calculation module 220 via a bus 230. The bus 230 could be I2C bus, SPI bus or other buses. The image sensing module 210 defines a size and position of the touch control area 160 shown in FIG. 1, captures at least one image which comprises the object 150 shown in FIG. 1, and obtains at least one image feature of the object 150 according to the at least one image. The calculation module 220 is coupled with the image sensing module 210 to receive the image feature, image parameter or image data of the object 150 from the image sensing module 210 via the bus 230, and calculates a location of the object 150 according to the at least one image feature. It should be noted that the size and position of the touch control area 160 defined by the image sensing module 210 are preferred to cover the whole control pattern 102 in order to adequately obtain the image feature, image parameter or image data by the optical sensing module 200.

Refer to FIG. 4B, which is a schematic diagram of another display apparatus 10 according to the first embodiment of the present invention. The same numeric labels in FIG. 4B represent the same or similar elements described above, and the detail operation method is not repeated here. The display apparatus 10 comprises an optical sensing module 200, a control circuit 130, a switch 140 and an indication unit 250. The indication unit 250 is coupled with the control circuit 130 to prompt the at least one function input to a user. The indication unit 250 could be one of a liquid crystal module, a speaker, an indication light and a vibration device. The optical sensing module 200 comprises a calculation module 200, an image sensing module 210, a bus 230 and a communication module 235. The communication module 235 is coupled with the calculation module 20 and is communicated with the control circuit 130. The communication between the communication module 235 and the control circuit 130 could be wired (such as, but not limited to, USB interface, SPI interface UART interface, I2C bus, etc.) or wireless (such as, but not limited to, Bluetooth, wireless local network, infrared, electro-magnetic wave, etc.).

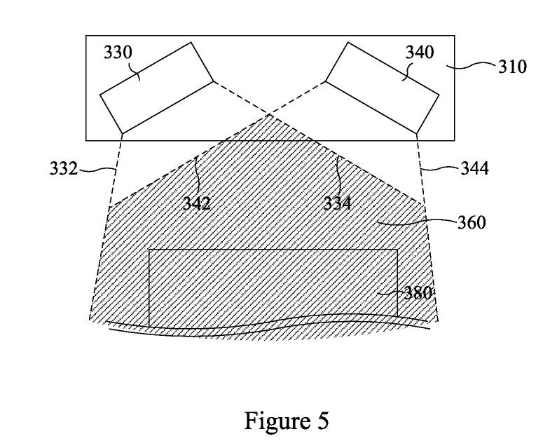

Refer to FIG. 5, which is a schematic diagram of an image sensing module used in the first embodiment according to one embodiment of the present invention, the way how the image sensing module 210 defines the touch control area is described in detail. In FIG. 5, the image sensing module 310 comprises image sensor 330 and 340. The image sensor 330 and 340 independently provide sensing ranges to sense the object within the sensing ranges, and the image sensor 330 and 340 could be CIS (CMOS Image Sensor) or CCD (Charge Coupled Device) sensor. As shown in FIG. 5, the sensing range of the image sensor 330 is the area between the dashed line 332 and the dashed line 334, and the sensing range of the image sensor 340 is the area between the dashed line 342 and the dashed line 344. The area overlapped by the two sensing ranges is the touch control area 360 defined by the image sensing module 310, and the control pattern 380 is preferred to be within the range covered by the touch control area 360. When an object enters the touch control area 30, the image sensor 330 and 340 would independently obtain the image features corresponding to the sensed object from the sensed image(s), and transmit the image features to the calculation module (as shown in FIG. 4A or 4B). The calculation module calculates the location of the object according to the received image features and transmits the location of the object to the control circuit (as shown in FIG. 1) such that the control circuit performs the corresponding operation according to the location of the object. In the embodiments of the present invention, the angles where the image sensor 330 and 340 are disposed are preferred, but is not limited, to be set to provide a maximum space of the touch control area 360.

It should be noted that although two image sensors 330 and 340 are taught in this embodiment to sense images and define the touch control area 360, single image sensor could work as well. When the image sensor 330 or 340 is used to sense images, the touch control area 360 defined by the image sensing module is determined by the sensing range of the image sensor 330 or 340. Moreover, in order to ease the effort for calculating the location of the object, the distance between the two image sensors 330 and 340 would be preset to a fixed value that is equal to or smaller than any side of the panel when two image sensors 330 and 340 are used at the same time. Furthermore, the image sensors 330 and 340 are on the same horizontal level correlating to a display surface of the panel.

Thereafter, in order to make the control circuit to perform the operation corresponding to the received location of the object, operation instruction(s) corresponding to each location of the object should be pre-defined. Furthermore, since the control circuit is operated corresponding to the control of the users, the operation instructions corresponding to the locations should be clearly known by the users. In general, the content of the control pattern can be formed by etching positions of the buttons, sample patterns or descriptions on the surface 300 within the touch control area 360 via etching process, or attaching a carrier with specific patterns, such as a pater with printed buttons, onto the surface 300 within the touch control area 360 instead. Moreover, when working with the display apparatus 10 (shown in FIG. 1) described in the first embodiment, the corresponding control interface could be displayed within the touch control area 360 shown in FIG. 5 if necessary. For example, the function icons of the control pattern could be a mapping image of the physical remote controller of the display apparatus 10. Such that users could know the meanings of the buttons and then operate the display apparatus via the optical sensing module accordingly. Besides this, the control pattern would not exceed the whole display area of the panel (hereinafter, full-frame display area) since the control pattern is displayed by the panel so that the size of the touch control area can be limited to be equal to or less than the range of the full-frame display area.

Please refer back to FIG. 1. According to the descriptions above, the location of the object 150 could provide information with specific meanings through a designed content of the control pattern 102. In other words, after the optical sensing module 120 is activated and obtains the location of the object 150, the control circuit 130 could determines whether the object 150 touches the control pattern 102, i.e. the object 150 is within the range of the control pattern 102, according to the location of the object 150 and when the object 150 touches the control pattern 102, it is further determined that whether the object touches a specific icon combination, i.e. the relationship between the location of the object 150 and the position of each function icon 104. At the same time, the function input corresponding to the specific icon combination touched by the object 150 is determined. Through the determination described above, the control circuit 130 could perform an operation, such as volume control, channel selection, panel adjustment, video input selection or numeric input, corresponding to the location of the object 150 so as to satisfy a goal of the user operation.

In order to achieve the abovementioned effect, an operation for detecting the location of the object 150 by the optical sensing module 120 is very important. In the first embodiment, the optical sensing module 120 comprises an image sensing module as shown in FIG. 4A or 4B, and at least one image sensor is required for sensing images in an image sensing module. Preferably, two image sensors could be used in one image sensing module (as shown in FIG. 5) to position the location of the object more precisely. The two image sensors used in one image sensing module could have an internal structure the same as each other or could have an internal structure different from each other.

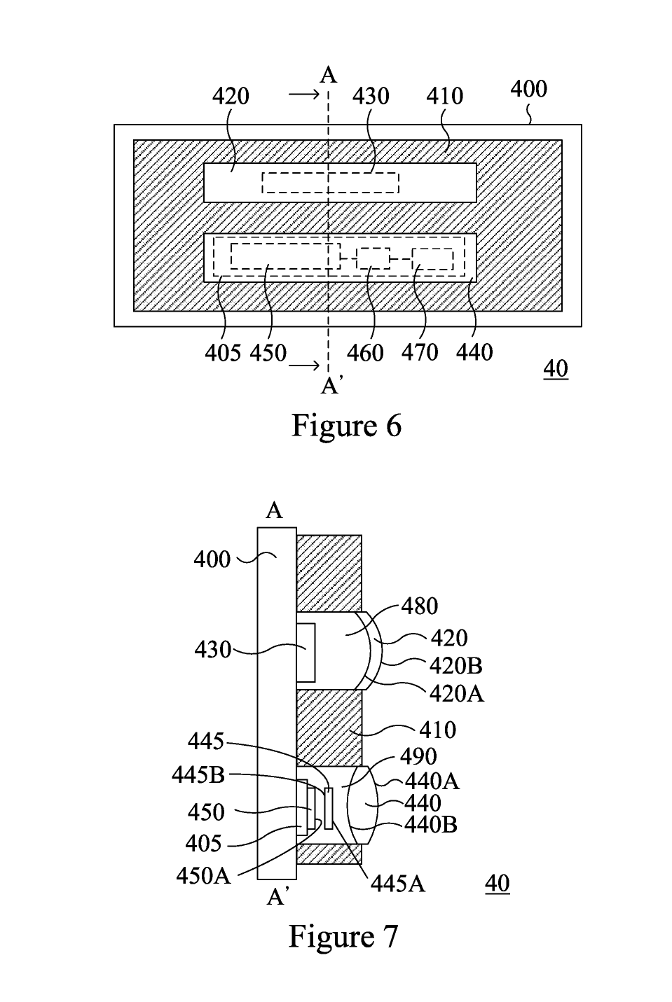

Refer to FIG. 6 and FIG. 7 at the same time, wherein FIG. 6 is a schematic diagram of a front view of the image sensing module used in the first embodiment of the present invention, and FIG. 7 is a cross-sectional diagram along the line A-A′ of the image sensor shown in FIG. 6. As shown in FIGS. 6 and 7, the image sensor 40 is disposed on the circuit board 400 and comprises a base 410, a first lens set 420, an infrared emitting unit 430, a second lens set 440, an infrared filter 445, a sensing unit 450, a register 460 and a pre-processing circuit 470. The base 410 is composed of an optical isolation material, wherein a first accommodation room 480 and a second accommodation room 490 independent from each other are formed in the base 410. The infrared emitting unit 430 is disposed in the first accommodation room 480, the sensing unit 450 is disposed in the second accommodation room 490, and the optical isolation material separates the first accommodation room 480 and the second accommodation room 490 so that an outgoing infrared ray, of which the wave length is about 850 nm or 940 nm, emitted from the infrared emitting unit 430 would not directly go into the second accommodation room 490 or, in another word, the outgoing infrared ray emitted from the infrared emitting unit 430 does not directly fall onto the second lens set 440, the infrared filter 445 and the sensing unit 450 due to the optical isolation material. Besides this, a lower side of the image sensor 40 would be closer to a display surface of the panel shown in FIG. 1. That is, the shortest distance between the infrared emitting unit 430 and the panel would be greater than the shortest distance between the sensing unit 450 and the panel.

In the present embodiment, the first lens set 420 is disposed at a side where the infrared emitting unit 430 emits the outgoing infrared ray so that the outgoing infrared ray emitted from the infrared emitting unit 430 falls onto an incidence surface 420A of the first lens set 420, and then, the outgoing infrared ray is refracted by a refraction surface 420B of the first lens set 420 to expand an illuminating range of the outgoing infrared ray. When an object appears in the sensing range of the image sensor 40, the light hits the object, which comprises at least a part of the outgoing infrared ray, would be reflected to the incidence surface 440A of the second lens set 440. For easy understanding, the light reflected from the object is termed as reflective light hereinafter. The incidence surface 440A receives the reflective light and then the reflective light is refracted by the refraction surface 440B to converge the reflective light. The infrared filter is disposed between the sensing unit 450 and the second lens set 440. That is, a first surface 445A of the infrared filter 445 faces the refraction surface 440B so that the converged refraction ray could go into the infrared filter 445 through the first surface 445A. After filtered by the infrared filter 445, an incoming infrared ray is obtained at the second surface 445B while lights other than infrared ray in the converged refraction ray are filtered. The incoming infrared ray passes through the infrared lens 445 and then falls onto the sensing surface 450A of the sensing unit 450. It should be noted that, the reflective light would be filtered and the incoming infrared ray could be obtained and refracted onto the sensing unit 450 as well even if the positions of the infrared filter 445 and the second lens set 440 are switched, i.e. even if the second lens 440 is disposed between the infrared lens 445 and the sensing unit 450. Therefore, the positions of the infrared filter 445 and the second lens set are not limited to what is shown in FIG. 7.

In this embodiment, the sensing unit 450 and the second lens set 440 are disposed at different sides of the infrared filter 445, that is, the sensing surface 450A faces the second surface 445B of the infrared filter 445, so that the incoming infrared ray could hit the sensing surface 450A of the sensing unit 450. Furthermore, the sensing unit 450 is composed of a pixel array of 640*8 or 720*6 in the present embodiment. After receiving the incoming infrared ray, the sensing unit 450 integrates the received incoming infrared ray into an image. The image could be stored in the register 460 which is coupled with the sensing unit 450. At least one image feature would be obtained after the image stored in the register 460 is processed by the pre-processing circuit 470, which is coupled with the register 460. The obtained image feature is then provided to the calculation module (as shown in FIG. 4A or 4B) to calculate the location of the object. It should be noted that, although the sensing unit 450, the register 460 and the pre-processing circuit 470 are assembled on the same substrate 406, the base 410, the infrared emitting unit 430 and the substrate 405 are disposed on the same circuit board 400, and the first lens set 420, the second set 440 and the infrared filter 445 are fixed on the optical isolation material of the base 410 in the present embodiment, these are not necessary conditions. Adjusting of the structures can be made by those skilled in the art under the same theory of design. For example, an infrared transmitting material could be directly coated on the refraction surface 440B of the second lens set 440 to form the infrared filter 445 (such as, at least one lens in the lens set is alternated coated with multi-layered MgO and multi-layered TiO₂ or SiO₂ so that at least one lens provides the effect of infrared filtering); the infrared filter 445 could be directly attached onto the sensing surface 450A of the sensing unit 450; or the pre-processing circuit 470 could be integrated into the calculation module 220 shown in FIG. 4A or 4B.

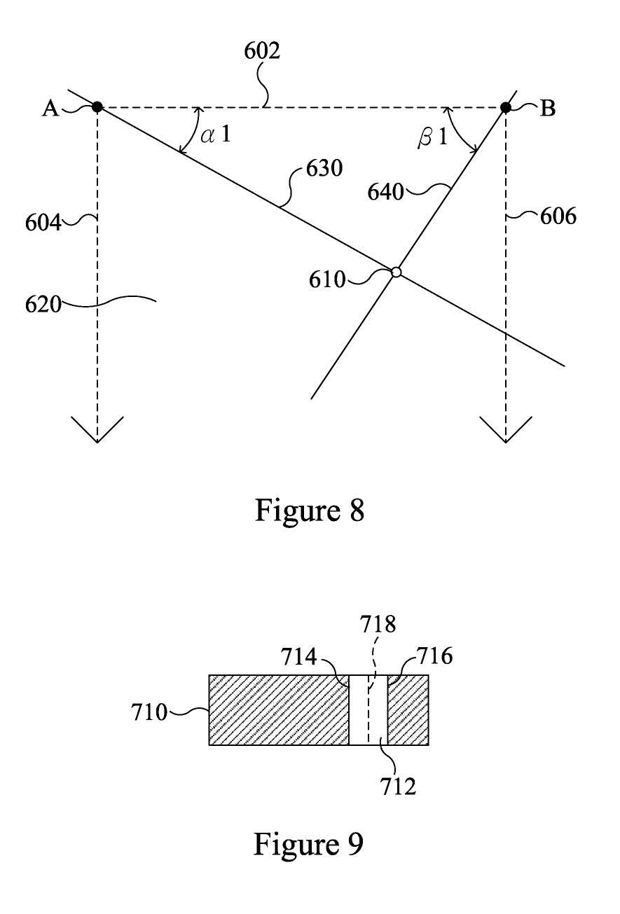

The operation method of the calculation module and the pre-processing circuit will be discussed in details. Please refer to FIG. 8, which is an illustration of a method for calculating a position of the object via the calculation module according to one embodiment of the present invention. In FIG. 8, there exists a specific distance between the two image sensors A and B. Assuming that the sensing range of the image sensor A is adjusted to 90 degree between the dashed line 602 and 604, and the sensing range of the image sensor B is adjusted to 90 degree between the dashed line 602 and 606, when the object enters the touch control area 620 (for example, at the point 610), the calculation module could calculate the location of the point 610 in the touch control area 620 according to the angle α1 between the straight line 630 extended from the image sensor A to the point 610 and the dashed line 602, the angle β1 between the straight line 640 extended from the image sensor B to the point 610 and the dashed line 602, and the specific distance between the image sensor A and the image sensor B.

The angle α1 and the angle β1 are the image features generated by the image sensor A and image sensor B in this embodiment. Please refer to FIG. 9 at the same time, which is a schematic diagram of an image data of the image sensor according to one embodiment of the present invention. As shown in FIG. 9, when an object enters the touch control area, there is a high-lighted area (the white block 712 between line 714 and line 716) in the image data 710 sensed by the image sensor due to the infrared light reflected from the object while other areas in the image data being darker than the white block 712. Because the sensing ranges of the image sensor A and B are assumed to be 90 degree, the image data 710 represents an image with different grey levels for a range of 90 degree. Therefore, the image data 710 could be divided into 90 segments from left to right. When the image data 710 is the image obtained by the image sensor A, the right edge of the image data 710 represents that the angle between the straight line 630 and the dashed line 602 is 0 degree, i.e. the object is sensed along the dashed line 602 shown in FIG. 8. The left edge of the image data 710 represents what is sensed along the dashed line 604, and the image between the right and left edge represents that the angle between the straight line 630 and the dashed line 602 is 90 degree, i.e. the object is sensed along the dashed line 604 shown in FIG. 8. Any angles between the dashed lines 602 and 604 could be obtained by the segments in sequence.

Similarly, when the image data 710 is the image obtained by the image sensor B, the right edge of the image data 710 represents that the object is sensed along the dashed line 606 shown in FIG. 8 while the left edge of the image data 710 represents that the object is sensed along the dashed line 602. Any angles between the dashed lines 602 and 606 could be obtained by the segments in sequence.

Accordingly, the angle α1 or β1 can be obtained as long as the segment where the white block 712 of the image data 710 exists is obtained. As the amount of segments increased, an angle difference between two neighbored segments would be smaller, and the precision of image sensing could be enhanced. However, because the size of the white block 712 may be greater than the size of one segment, a plurality of algorithms could be applied in the pre-processing circuit in advance to calculate a specific point of the white block 712, such as barycenter or physical center of the white block 712, and then the angle α1 or β1 can be determined according to the segment where the specific point of the white block 712 exists. For example, the segment where the dashed line 718 crosses the barycenter of the white block 712 could be used to determine the angle α1 or β1.

When the image feature such as area, length-to-width ratio, margins, colors, brightness or angle α1 or β1 of the image, is transmitted to the calculation module, the calculation module could calculate the location of the point 610 according to the received image feature and the distance between the image sensors A and B (usually, the distance is stored in the calculation module or other storages). The obtained location is transmitted to the control circuit as shown in FIG. 1 from the calculation module, and then the control circuit finds out a corresponding operation instruction via look-up table or other algorithms according to the received location, and finally operates according to the operation instruction.

For example, after receiving the image data 710, a position parameter is obtained by calculating the position of the barycenter (centroid) of the pixels corresponding to the reflective light distribution of the image data 710 (i.e. the pixels in the white block 712). Thereafter, a reference record is applied with the position parameter to estimate the relative distance between the object and the light source or between the object or the image sensors. The reference record comprises reference position parameters set in a setting process for comparing relative distances.

The setting process mentioned above is applied to obtain a reflective light distribution of a reference object when the location of the reference object is known, and further obtain a relationship formula of location and distance by calculating barycenter according to the distributed reflective light. Afterwards the actual distance between the touch object and the light source or between the touch object and the sensing units by using the relationship formula during the operation. The relationship formula could be implemented by building a look-up table, deriving a formula of relative distance, shift angles and barycenter position, or forming a chart to show the relationship of the relative distance and the shift angles among the touch object, the light source and the sensing unit.

Through implementing the hardware and relative operation methods, the display apparatus in the first embodiment can be controlled by using optical sensing methods.

### Second Embodiment

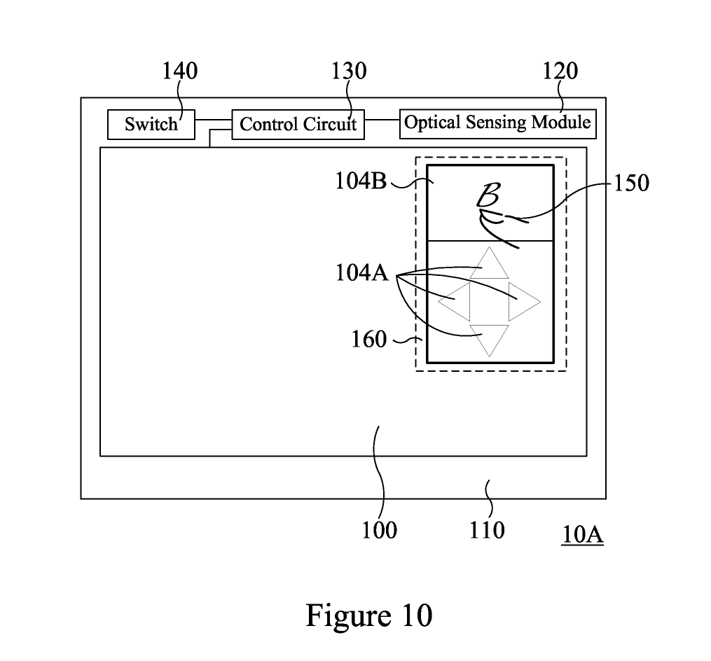

In the second embodiment, the present invention uses the same hardware in the first embodiment with a different operation method to achieve optical sensing control over the display apparatus. Please refer to FIG. 10, which is a schematic diagram of a display apparatus according to the second embodiment of the present invention.

The major difference between the second embodiment and the first embodiment is that the panel 100 of the display apparatus 10A could be used to display an input area 104B, and the optical sensing module 120 could be used to detect a moving trace of an object 150 in the touch control area 160. The input area 104B is used for receiving a writing input command from the user. That is, when the object 150 (such as finger of the user) moves in the input area 104B, the optical sensing module 120 could detect the moving trace of the object 150. After that, the control circuit 130 determines whether the moving trace of the object 150 is an identifiable instruction. When the control circuit 130 determines that the moving trace of the object 150 is an identifiable instruction, the control circuit 130 performs a function corresponding to the identifiable instruction. In other embodiments of the present invention, the panel 100 could further display the function icons 104A besides the input area 104B when the moving trace is determined to be an identifiable instruction by the control circuit 130. The method for determining whether the function icons 104A are touched or not in the first embodiment could be applied here. That is, the relationship between the location of the object 150 and the positions of the function icons 104A is used to determine whether the object 150 touches an icon combination formed by selecting at least one of the function icons in a specific sequence. A known technique that identifies the writing input by detecting the moving trace of the object by the optical sensing method can be applied here to identify the writing input command. That is, the optical sensing module and the control circuit in the second embodiment should support the reading and determination of the moving trace of the object. This kind of design could increase the flexibility of the command input and makes it more convenient to use. For example, the user can write “BR” in the input area 104B to indicate that the parameter of brightness is what the user wants to adjust. The panel 100 displays function icons 104A to interact with the user when the control circuit 130 determines that the user inputs “BR” according to the moving trace of the finger. At this time, the direction button in the function icons 104A can be used for adjusting the level of the brightness. At another time, when the user writes “CH” in the input area to indicate that the user wants to select a specific channel, the direction button in the function icons 104A can be used for switching channels. Under the condition that only the input area 104B is available, the user can sequentially write the words “C”, “H”, “1”, “0” and “4” to indicate that the user wants to switch the display apparatus 10A to 104^{th} channel. The function icons 104A in this embodiment is not a necessary element, but it can be provided after a writing command is input by the user for further controlling.

### Third Embodiment

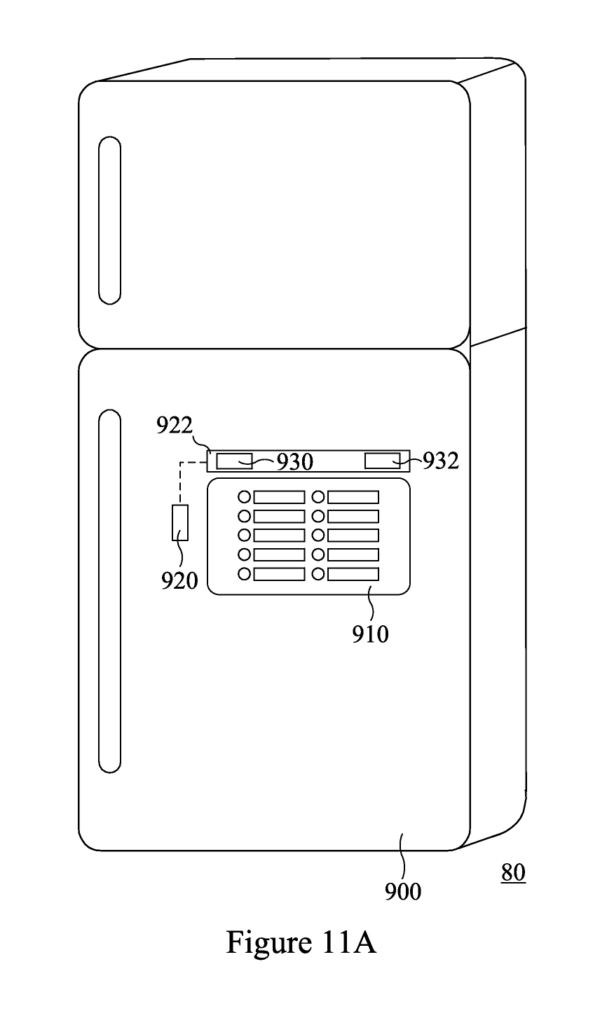

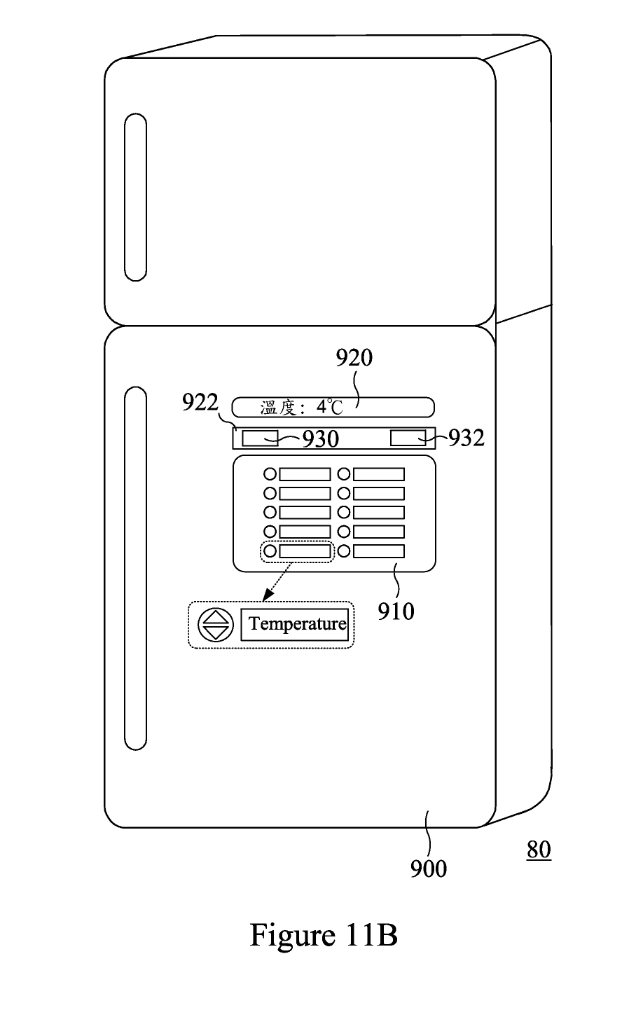

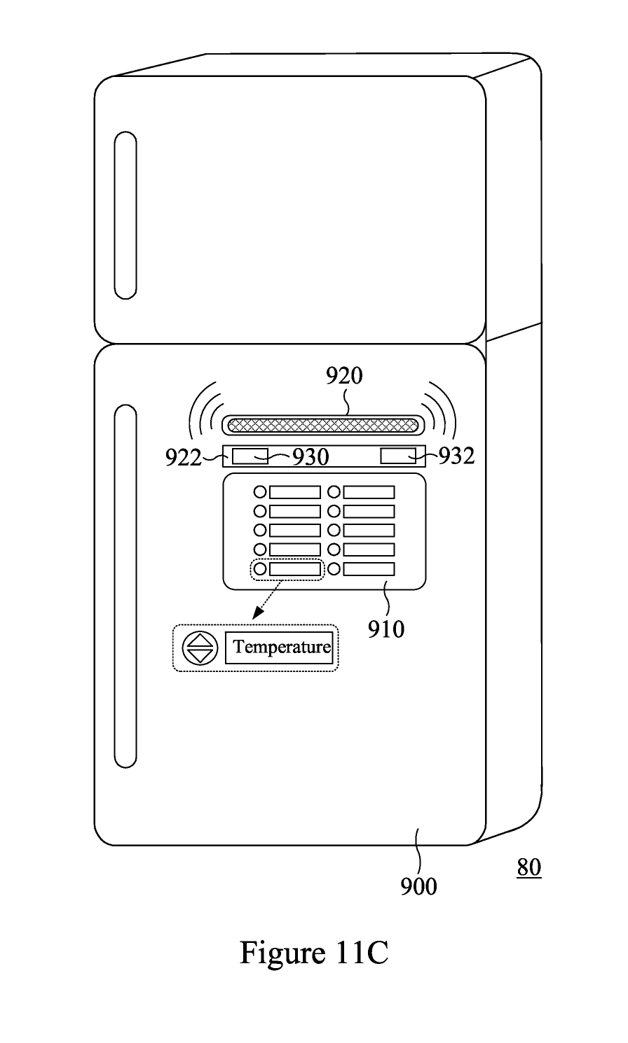

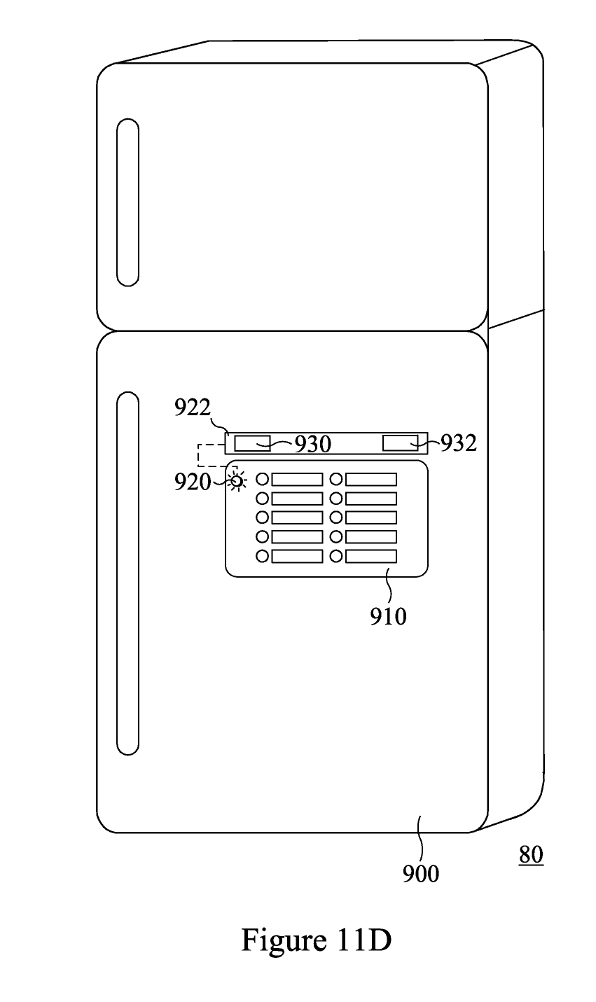

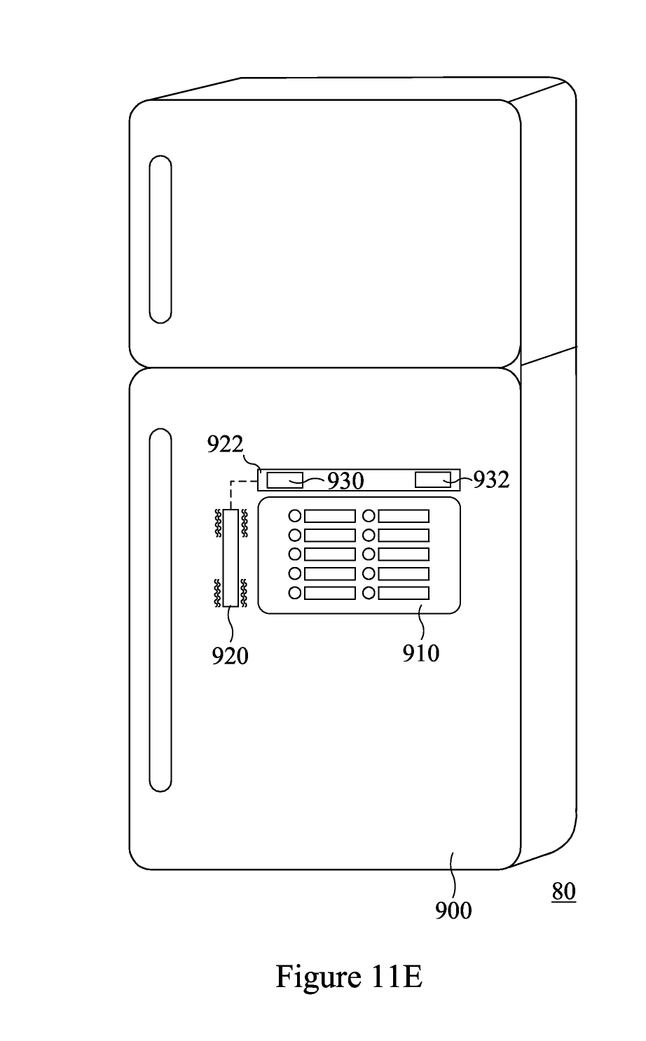

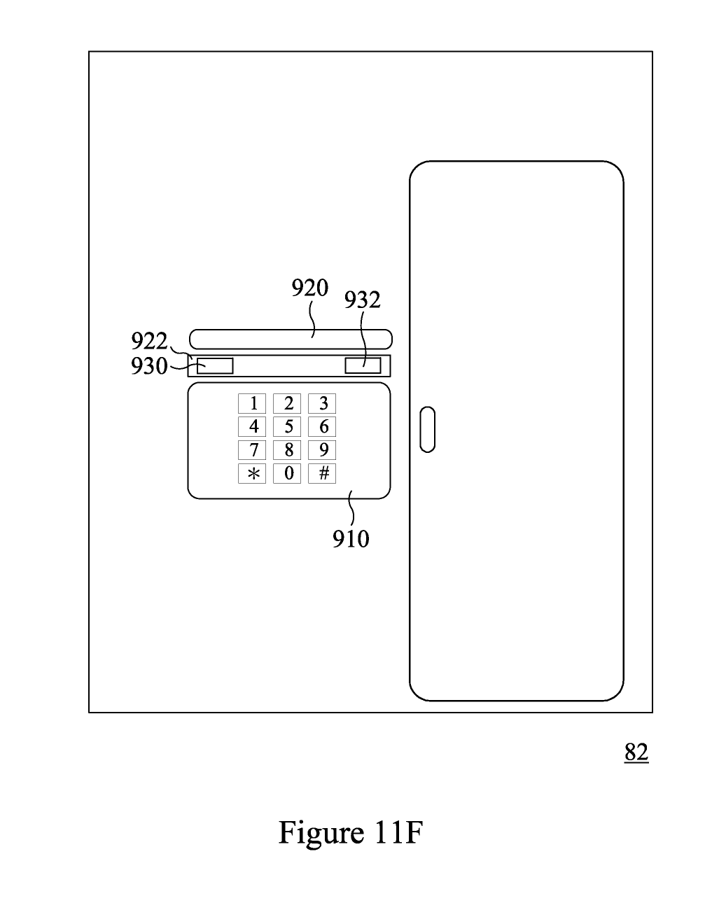

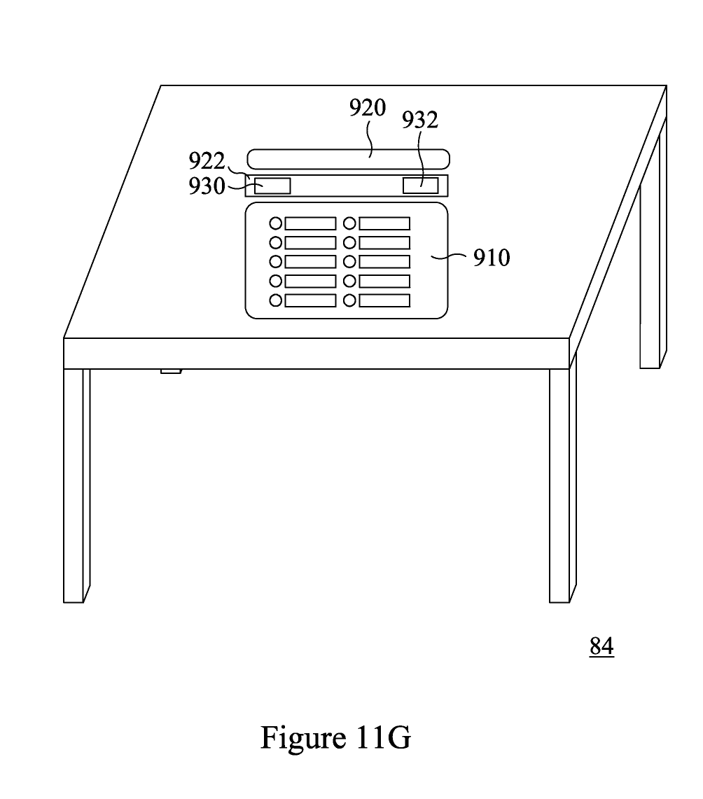

Please refer to FIG. 11A, which is a schematic diagram of an electronic apparatus according to the third embodiment of the present invention. In the present embodiment, the electronic apparatus 80 could be a fridge, which mainly comprises a surface 900, a touched object 910 and an optical sensing module 922. The optical sensing module 922 uses two image sensors 930 and 932 to sense images, and the structure of the sensing module 922 is the same as the optical sensing modules 120 and 200, and therefore the detail operation method is not repeated here.

The touched object 910 corresponds to the function input(s) of the electronic apparatus 80. In the present embodiment, the touched object 910 comprises a plurality of button icons (represented by circles) and a plurality of square frames providing corresponded text description (represented by square frames). The user could control the electronic apparatus 80 to perform a corresponded operation by pointing at the button icons or the square frames. The function input comprises temperature control, menu selection, time/data adjustment, code input selection, numeric input, etc. Identification and positioning method required for operating the optical sensing module 922 is described in the previous embodiments and is not repeated here.

The function of the touched object 910 is similar to that of the control pattern shown by the panel in FIG. 1. However, because the electronic apparatus 80 might not comprise a panel or display elements, a carrier with specific patterns, such as a sheet of paper or soft pad with printed 2D or 3D button patterns, a sheet of paper or soft pad having a gesture input area, or a sheet of paper or soft pad with printed 2D or 3D button patterns and a gesture input area is used in this embodiment, where the carrier is attached onto the surface 900 as the touched object 910. This kind of design can be applied on the electronic apparatus without a display device, for example, large appliances such as fridge or air conditioner. Besides this, the electronic apparatus 80 further comprises an indication unit 920 in this embodiment. When the control circuit (e.g. control circuit 130) determines that the object touches the touched object 910, the indication unit 920 prompts a status of the electronic apparatus to the users, or displays the function that is chosen by the user and sensed by the optical sensing module 922, so as to interact with the user and make it easier for a user to determine whether the selected function is really correct. In other embodiments of the present invention, the indication unit 920 might be removed by those with ordinary skill in the art due to requirement of the users (such as cost or circuit structure). For example, the indication unit 920 could be at least one of a liquid crystal panel, speaker, indication light and vibration apparatus. Please refer to FIG. 11B, which is a schematic diagram of one variation of the electronic apparatus according to the third embodiment of the present invention. When the user touches the temperature item of the touched object 910, the liquid crystal panel displays the current temperature (for example, 4° C.) of the fridge. When the user adjusts the temperature of the fridge through the touched object 910, the liquid crystal panel could display the newly set temperature to interact with the user.

In another embodiment of the present invention, the indication unit 920 could be a speaker. Please refer to FIG. 11C, which is a schematic diagram of one variation of the electronic apparatus according to the third embodiment of the present invention. When the user touches the temperature item of the touched object 910, the speaker sends out a sound to interact with the user. For example, the speaker could send out a voice speech of “the current temperature is 4° C.” or only a long “beep”. When the user adjusts the temperature of the fridge through the touched object 910, the speaker sends out corresponding sound to prompt the set temperature to the user. For example, when the temperature is decreased, the speaker sends out two long “beep”, and, when the temperature is increased, the speaker sends out on short “beep”. The speaker in the present invention could be set according to requirement of the users and is not limited to what is described above.

In another embodiment of the present invention, the indication unit 920 could be an indication light. Please refer to FIG. 11D, which is a schematic diagram of one variation of the electronic apparatus according to the third embodiment of the present invention. When the user touches the temperature item of the touched object 910, the indication light shines to interact with the user. When the user adjusts the temperature of the fridge through the touched object 910, the indication light flickers. The flicker frequency of the indication light can be set by the user according to his requirement. It is noted that, the indication light could be integrated with the optical sensing module 922 or the touched object 910, or it could be an independent apparatus.

In another embodiment of the present invention, the indication unit 920 could be a vibration apparatus. Please refer to FIG. 11E, which is a schematic diagram of one variation of the electronic apparatus according to the third embodiment of the present invention. When the user selects the temperature item of the touched object 910, the vibration apparatus would vibrate to prompt the user. When the temperature of the fridge is adjusted by the user through the touched object 910, the frequency or strength of the vibration generated from the vibration apparatus could be changed. For example, the strength of the vibration is weaker when the temperature is lower, and the strength of the vibration is stronger when the temperature is higher. The frequency or strength of the vibration can be set according to requirement of the users, and therefore is not limited to what described above.

It is noted that, other than the implementations described above, the indication unit of the present invention could comprise at least two of the liquid crystal panel, speaker, indication light and vibration apparatus. For example, when the user touches the temperature item of the touched object 910, the indication light shines. When the user turns up the temperature of the fridge through the touched object 910, the speaker sends out a long “beep”. When the user turns down the temperature of the fridge through the touched object 910, the speaker sends out two short “beep”.

Besides the large appliances such as fridge, the present embodiment could be applied to other appliances. For example, please refer to FIG. 11F, the electronic apparatus 82 is a door with an electronic lock. In this embodiment, the optical sensing module 922 senses the object on the touched object by using the image sensors 930 and 932, and therefore the user could unlock the electronic lock through touching the numeric buttons of the touched object 910. The indication unit 920 could display specific symbols to show the digits of digitals input by the user, or display the input digital directly when it is necessary. In another example, please refer to FIGS. 11H and 11G, the electronic apparatus 84 is a table with a meal ordering function. Similarly, the optical sensing module 922 senses the object on the touched object by using the image sensors 930 and 932, therefore the user could order the meal by touching the menu button (represented by circles) or the content of a meal (represented by square frame) of the touched object 910. The indication unit 920 could display the items selected by the user for confirmation. Similarly, the indication unit 920 could be removed by those with ordinary skill in the art according to requirement (such as cost or circuit structure) of the users.

### Fourth Embodiment

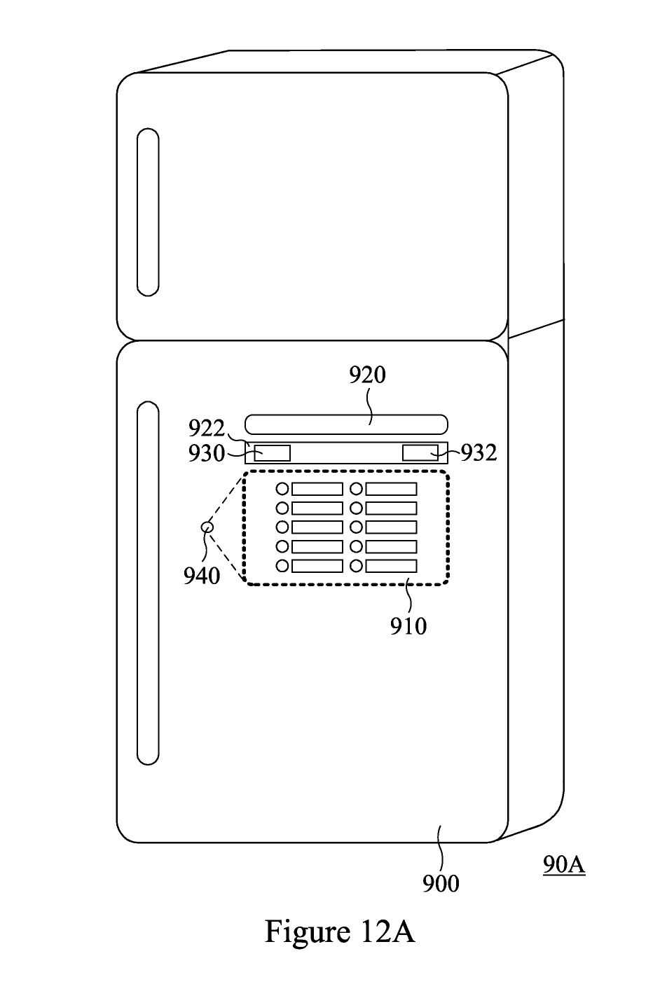

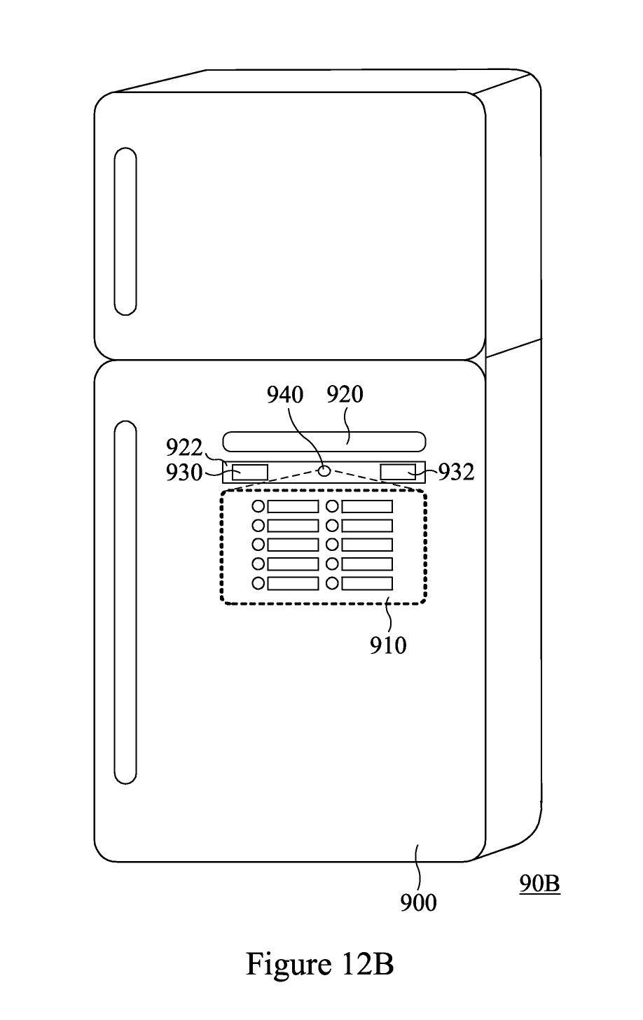

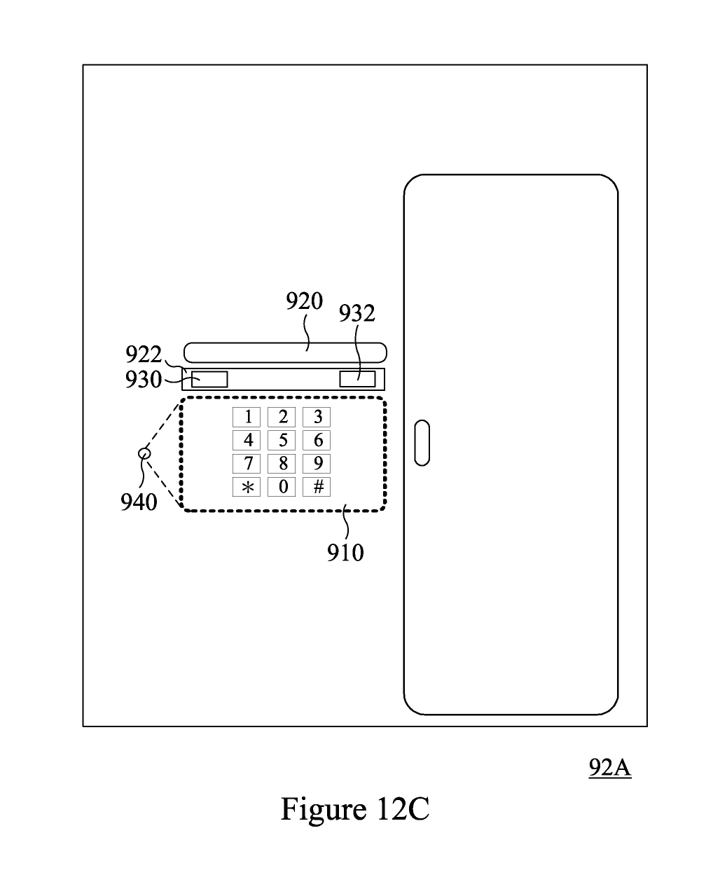

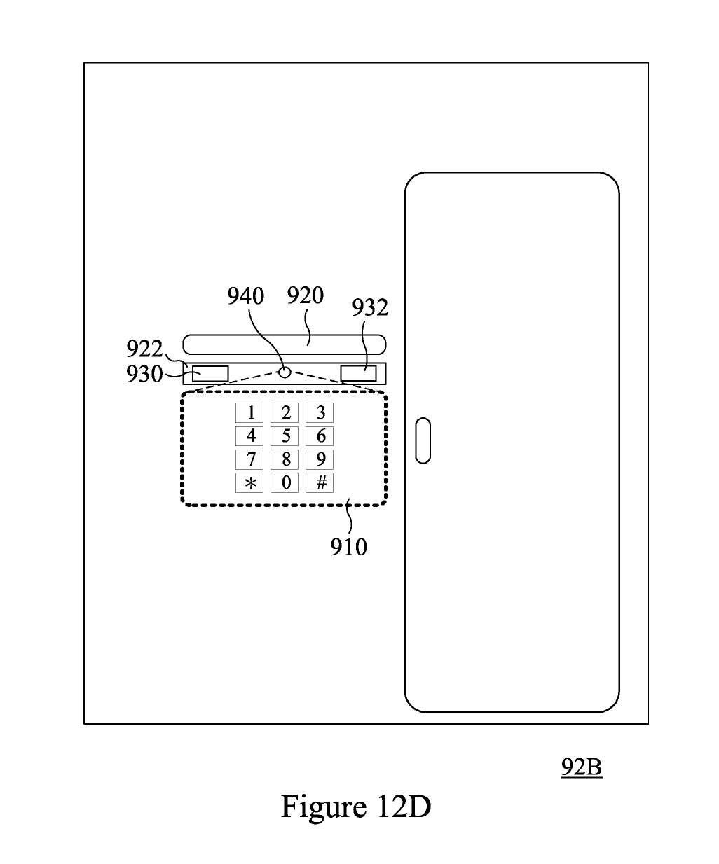

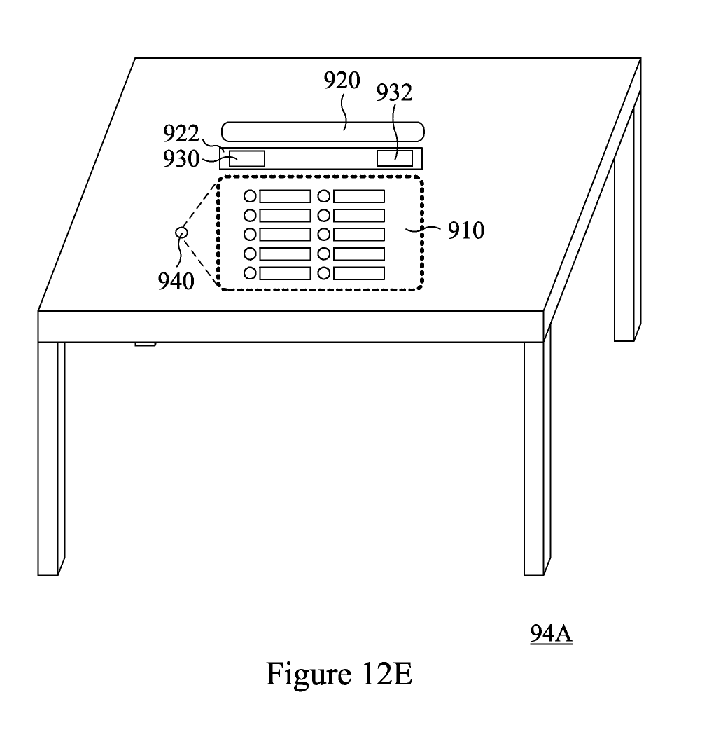

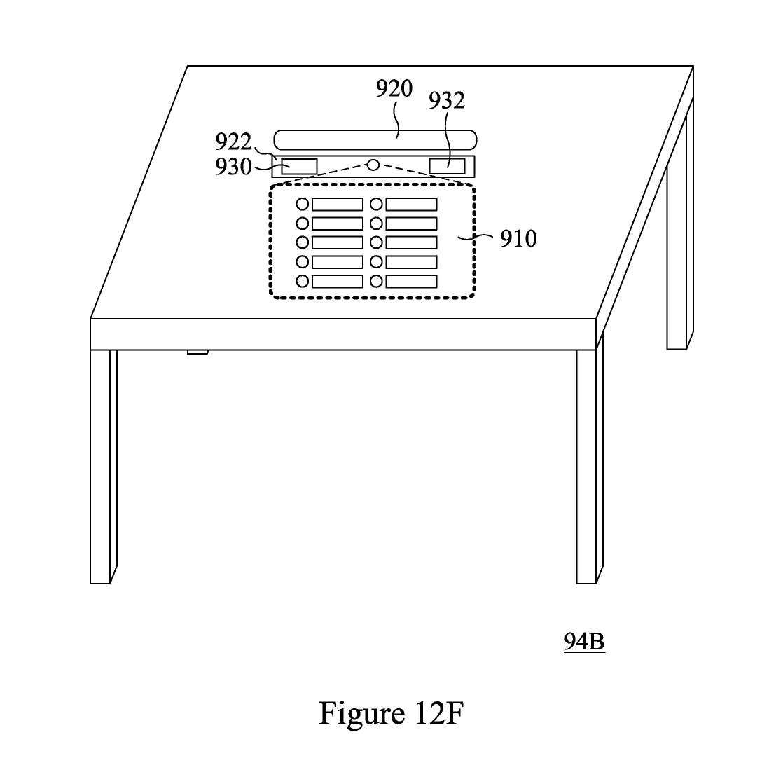

Please refer to FIG. 12A, which is a schematic diagram of an electronic apparatus according to the fourth embodiment of the present invention. Compared with the third embodiment, the electronic apparatus 90A in the fourth embodiment also comprises a surface 900, a touched object 910 and an optical sensing module 922, where the optical sensing module 922 uses two image sensors 930 and 932 for image sensing. The major difference between the fourth embodiment and the third embodiment is that a pico-projector 940 is disposed on the surface 900, and the touched object 910 is a 2D or 3D image projected onto the surface 900 by the pico-projector 940. Besides the difference mentioned above, the fourth embodiment is similar to the third embodiment and therefore the description is not repeated here.

Please refer to FIG. 12B, the electronic apparatus 90B shown therein is similar to that shown in FIG. 12A. However, the pico-projector 940 is integrated with the optical sensing module 922 to reduce the complexity of assembling the electronic elements in this embodiment. Similarly, please refer to FIG. 12C and FIG. 12D, the electronic apparatus 92A and the electronic apparatus 92B are similar to the electronic apparatus 82 shown in FIG. 11B. The electronic apparatus 92A projects the touched object 910 by the pico-project 940 disposed on the surface 900, and the electronic apparatus 92B further integrates the pico-projector 940 with the optical sensing module 922. Please refer to FIG. 12E and FIG. 12F, the electronic apparatus 94A and the electronic apparatus 94B are similar to the electronic apparatus 84 shown in FIG. 11C, the electronic apparatus 94A projects the touched object 910 by the pico-project 940 disposed on the surface 900, and the electronic apparatus 94B further integrates the pico-projector 940 with the optical sensing module 922.

Through projecting the touched object by the pico-projector and adjusting the position of the touched object, the flexibility for designing control items of the electronic apparatus could be increased and the interaction between the electronic apparatus and the users would be better.

### Fifth Embodiment

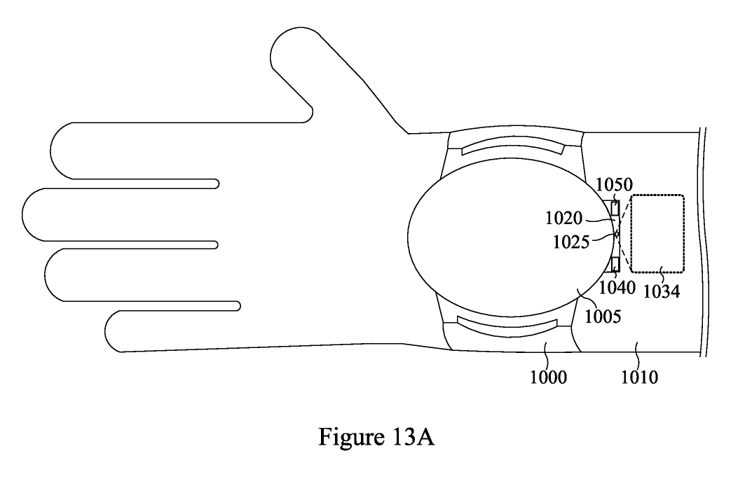

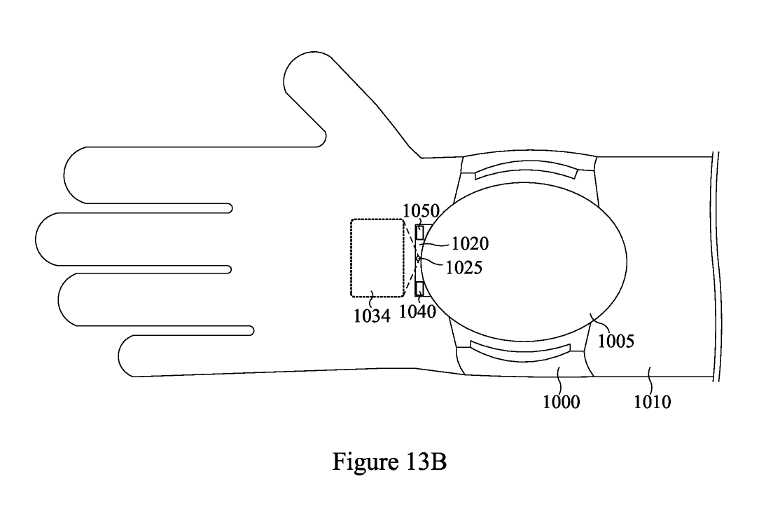

Please refer to FIG. 13A and FIG. 13B, which are schematic diagrams of a hand-wearing apparatus according to the fifth embodiment of the present invention. In this embodiment, the hand-wearing apparatus 1000 is adapted to be worn on the surface 1010 of the hand. The hand-wearing apparatus 1000 mainly comprises a case 1005 and an optical sensing module 1020. The optical sensing module 1020 is disposed on the case 1005, and two image sensors 1040 and 1050 are used to define a touch control area and sense the position information of the object in the defined touch control area. Users could input instructions to the hand-wearing apparatus 1000 through gestures in the touch control area or could project a 2D or 3D image onto the surface 1010 of the hand through a pico-projector 1025 integrated in the optical sensing module 1020 to form a touched object 1034 in the touch control area defined by the optical sensing module 1020 so that a position information of the fingers or other objects in the touch control area could be sensed by the optical sensing module 1020 to interact with the users when they touch the touched object 1034. Identification and positioning method required for operating the optical sensing module is described in the previous embodiments and is not repeated here. Furthermore, when the optical sensing module 1030 uses the image sensor shown in FIG. 6 and FIG. 7, the shortest distance between the infrared emitting unit and the hand surface 1010 is greater than the shortest distance between the sensing unit and the hand surface 1010. It should be noted that, the pico-projector 1025 could project the 2D or 3D image onto the surface of other parts of the human body (such as face, leg, chest or belly) than the surface of the wrist or the back of the hand.

Moreover, the pico-projector 1025 could project the image to the places other than the hand surface 1010. For example, the image could be projected on the case 1005 or in the air. Furthermore, the pico-projector 1025 could be independent from the optical sensing module 1020, and the touch control area could be defined on a specific area of the case 1005 such that the hand-wearing apparatus 1000 could be operated through optical touching control by the touch control structure described in the first to third embodiments mentioned above.

### Sixth Embodiment

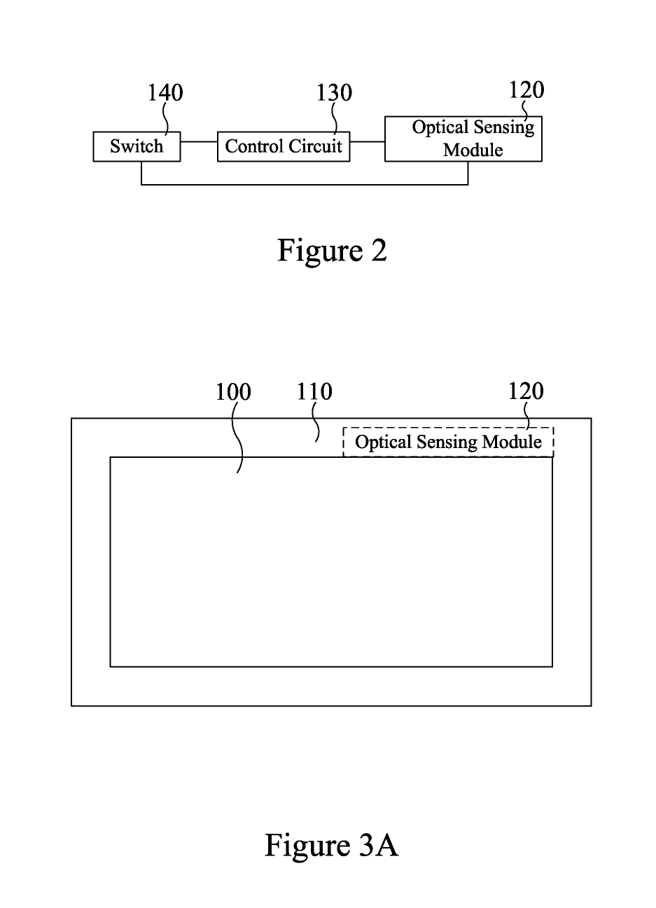

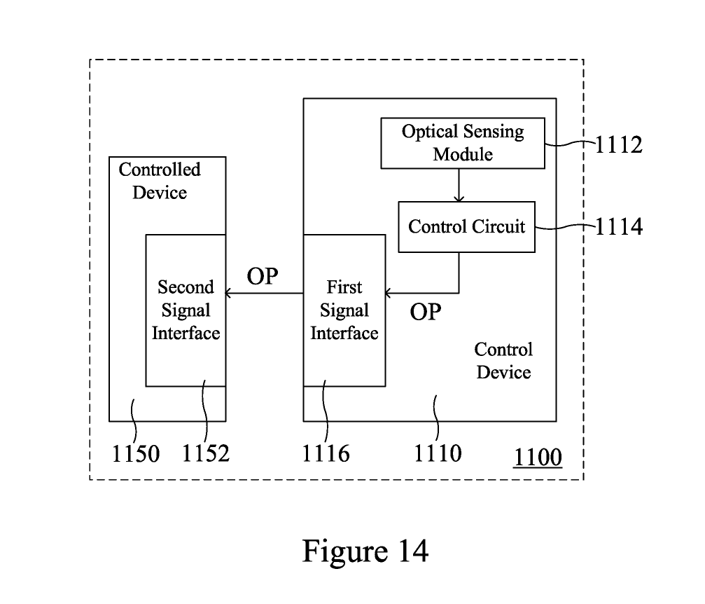

Please refer to FIG. 14, which is a circuit block diagram of a control system according to the sixth embodiment of the present invention. In the present embodiment, the control system 1100 comprises a control apparatus 1110 and a controlled apparatus 1150, wherein the control apparatus 1110 could be any one or variation of the apparatuses described in the first to fourth embodiments. The internal circuit, hardware structure, connection relationship and operation method thereof could be referred to those descriptions describing FIG. 1 to FIG. 10, and is not repeated here.

It is noted that, in the present embodiment, the control apparatus 1110 and the controlled apparatus 1150 are two independent apparatuses. Users can control the operation of the controlled apparatus 1150 through the optical touching control function provided by the control apparatus 1110. Specifically, when the optical sensing module 1112 captures an image and obtains a position information of the object (such as the location or the moving trace of the object) after calculation, the control circuit 1114 could generate an operation signal OP corresponding to the position information. The position information OP is transmitted to the first signal interface 1116 coupled with the control circuit 1114, and the first signal interface 1116 would transmits the operation signal OP to the second signal interface 1152 after receiving the operation signal OP. After receiving the operation signal OP through the second signal interface 1152, the controlled apparatus 1150 could perform corresponding operation according to the operation signal OP. The first signal interface 1116 and the second signal interface 1152 could be wired (such as USB interface, SPI interface UART interface, etc.) or wireless (such as telecommunication network, wireless local network, etc.).

By applying the control system above, a manufacturer could change the operation method of electronic apparatus, such as an electronic lock, large appliances or electronic wall, to the method of optical sensing operation so as to reduce the area reserved for the operation interface on the electronic apparatus. The electronic apparatus such as large appliances or electronic wall can interact with the users through the control system mentioned above.

In summary, the present invention does not require physical buttons because an optical sensing method is applied to detect a position of an object. In addition, a space reserved for optical sensing and a layout of a plurality of virtual buttons are not subject to the hardware size. Accordingly, more buttons can be provided for an apparatus on the limited surface such that a more convenient operation for a user can be achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display apparatus characterized in comprising:
a panel to display a control pattern, wherein the control pattern comprises a plurality of function icons, and a function input of the display apparatus corresponding to an icon combination formed by selecting at least one of the function icons in a specific sequence;
a frame disposed on outside of the panel;
an optical sensing module disposed at the frame, wherein the optical sensing module defines a touch control area, detects a location of an object in the touch control area, and comprises:
an image sensing module for defining the touch control area, capturing at least one image which comprises the object, and obtaining at least one image feature of the object according to the at least one image, wherein the touch control area covers the control pattern; and
a calculation module coupled with the image sensing module to calculate the location of the object according to the at least one image feature;
a control circuit coupled with the optical sensing module and the panel, and executing the function input corresponding to the icon combination while determining, according to the location of the object, that function icons selected by the object forms the icon combination; and
a switch coupled with the control circuit for displaying the control pattern on the panel and activating the optical sensing module to sense the object while being turned on.

2. The display apparatus according to claim 1, wherein the optical sensing module further comprises a communication module coupled with the calculation module for communicating with the control circuit.

3. The display apparatus according to claim 1, further comprising an indication unit coupled with the control circuit to prompt the function input to a user.

4. The display apparatus according to claim 1, wherein the control circuit determines whether the object touches the icon combination according to a relationship between the locations of the object and selected function icons.

5. The display apparatus according to claim 1, wherein the image sensing module comprises a first image sensor with a first sensing range, and the first image sensor captures a first image of the at least one image and obtains a first image feature of the at least one image feature according to the first image.

6. The display apparatus according to claim 5, wherein the image sensing module further comprises a second image sensor with a second sensing range, and the second image sensor captures a second image of the at least one image and obtains a second image feature of the at least one image feature according to the second image, wherein an overlapping area, which is an area where the first sensing range overlapped with the second sensing range, defines the touch control area, and the first image sensor has the same structure as the second image sensor.

7. The display apparatus according to claim 6, wherein a distance between the first image sensor and the second image sensor is fixed, the distance between the first image sensor and the second image sensor is smaller than or equals to any side of the panel, or the first image sensor and the second image sensor are on the same horizontal level correlating to a display surface of the panel.

8. The display apparatus according to claim 6, wherein the first image sensor comprises:
a base, which is composed of an optical isolation material, wherein a first accommodation room and a second accommodation room are formed in the base;
an infrared emitting unit, which is disposed in the first accommodation room, for emitting an outgoing infrared ray;
a first lens set having a first incidence surface and a first refraction surface, the first incidence surface is disposed at a side where the infrared emitting unit emits the outgoing infrared ray, wherein an illuminating range of the outgoing infrared ray is expanded after the outgoing infrared ray being refracted by the first refraction surface;
a second lens set having a second incidence surface and a second refraction surface, wherein the second incidence surface receives a reflective light reflected by the object, and the second refraction surface converges the reflective light;
an infrared filter having a first surface and a second surface, wherein the first surface faces the second refraction surface, and the reflective light is filtered through infrared filter to obtain an incoming infrared ray;
a sensing unit disposed in the second accommodation room, wherein a sensing surface of the sensing unit faces the second surface of the infrared filter to receive the incoming infrared ray, and the sensing unit integrates the received incoming infrared ray into the first image;
a register coupled with the sensing unit to store the first image; and
a pre-processing circuit coupled with the register to receive the first image for processing the first image to obtain and output the first image feature;
wherein, the outgoing infrared ray does not fall onto the second lens set, the infrared filter and the sensing unit directly,
wherein, the infrared filter is fixed on the base, coupled to the sensing surface of the sensing unit, or made by coating an infrared transmitting material on the second refraction surface of the second lens set.

9. The display apparatus according to claim 8, wherein the sensing unit, the register and the pre-processing circuit are disposed on a substrate, and the base, the infrared emitting unit and the substrate are disposed on a circuit board.

10. A display apparatus characterized in comprising:
a panel to display an input area;
a frame disposed on outside of the panel;
an optical sensing module disposed at the frame, wherein the optical sensing module defines a touch control area, detects a moving trace of an object in the touch control area, and comprises:
an image sensing module for defining the touch control area, retrieving at least one image which comprises the object, and obtaining at least one image feature of the object according to the at least one image, wherein the touch control area covers the input area; and
a calculation module coupled with the image sensing module to calculate the moving trace of the object according to the at least one image feature;
a control circuit coupled with the optical sensing module and the panel, and executing a function input corresponding to the moving trace; and
a switch coupled with the control circuit to display the input area on the panel while being turned on.

11. The display apparatus according to claim 10, wherein the optical sensing module further comprises a communication module coupled with the calculation module for communicating with the control circuit.

12. The display apparatus according to claim 10, further comprising an indication unit coupled with the control circuit to prompt the function input to a user.

13. The display apparatus according to claim 10, wherein a plurality of buttons are displayed in the input area, and the control circuit determines whether the object touches a button combination, which is formed by selecting at least one of the buttons in a specific sequence, according to a relationship between the locations of the object and selected buttons.

14. The display apparatus according to claim 10, wherein the image sensing module comprises a first image sensor with a first sensing range, and the first image sensor captures a first image of the at least one image and obtains a first image feature of the at least one image feature according to the first image.

15. The display apparatus according to claim 14, wherein the image sensing module further comprises a second image sensor with a second sensing range, and the second image sensor captures a second image of the at least one image and obtains a second image feature of the at least one image feature according to the second image, wherein an overlapping area, which is an area where the first sensing range overlapped with the second sensing range, defines the touch control area.

16. The display apparatus according to claim 15, wherein a distance between the first image sensor and the second image sensor is fixed, or the first image sensor and the second image sensor are on the same horizontal level correlating to a display surface of the panel.

17. The display apparatus according to claim 14, wherein the first image sensor comprises:
a base, which is composed of an optical isolation material, wherein a first accommodation room and a second accommodation room are formed in the base;
an infrared emitting unit, which is disposed in the first accommodation room, for emitting an outgoing infrared ray;
a first lens set having a first incidence surface and a first refraction surface, the first incidence surface is disposed at a side where the infrared emitting unit emits the outgoing infrared ray, wherein an illuminating range of the outgoing infrared ray is expanded after the outgoing infrared ray being refracted by the first refraction surface;
a second lens set having a second incidence surface and a second refraction surface, wherein the second incidence surface receives a reflective light reflected by the object, and the second refraction surface converges the reflective light;
an infrared filter having a first surface and a second surface, wherein the first surface faces the second refraction surface, and the reflective light is filtered through infrared filter to obtain an incoming infrared ray;
a sensing unit disposed in the second accommodation room, wherein a sensing surface of the sensing unit faces the second surface of the infrared filter to receive the incoming infrared ray, and the sensing unit integrates the received incoming infrared ray into the first image;
a register coupled with the sensing unit to store the first image; and
a pre-processing circuit coupled with the register to receive the first image for processing the first image to obtain and output the first image feature;
wherein, the outgoing infrared ray does not fall onto the second lens set, the infrared filter and the sensing unit directly,
wherein, the infrared filter is fixed on the base, coupled to the sensing surface of the sensing unit, or made by coating an infrared transmitting material on the second refraction surface of the second lens set.

18. The display apparatus according to claim 17, wherein the sensing unit, the register and the pre-processing circuit are disposed on a substrate, and the base, the infrared emitting unit and the substrate are disposed on a circuit board.

19. An electronic apparatus characterized in comprising:
a surface;
a touched object attached onto the surface, wherein the touched object is a carrier with a specific pattern and is corresponding to at least one function input of the electronic apparatus;
an optical sensing module disposed on the surface, wherein the optical sensing module defines a touch control area, detects a position information of an object in the touch control area, and comprises:
an image sensing module for defining the touch control area, retrieving at least one image which comprises the object, and obtaining at least one image feature of the object according to the at least one image, wherein the touch control area covers the carrier; and
a calculation module coupled with the image sensing module to calculate the position information of the object according to the at least one image feature; and
a control circuit coupled with the optical sensing module, and executing one of the at least one function input, which corresponds to the position information, to control the electronic apparatus.

20. The electronic apparatus according to claim 19, wherein the optical sensing module further comprises a communication module coupled with the calculation module and communicated with the control circuit.

21. The electronic apparatus according to claim 19, wherein the position information comprises a coordinate and a moving trace of the object.

22. The electronic apparatus according to claim 19, further comprising an indication unit coupled with the control circuit to prompt the at least one function input to a user.

23. The electronic apparatus according to claim 19, wherein the control circuit determines whether the object touches the touched object according to a relationship between a location of the touched object and the location of the object calculated by the control circuit according to the position information.

24. The electronic apparatus according to claim 19, wherein the image sensing module comprises a first image sensor with a first sensing range, and the first image sensor captures a first image of the at least one image and obtains a first image feature of the at least one image feature according to the first image.

25. The electronic apparatus according to claim 24, wherein the image sensing module further comprises a second image sensor with a second sensing range, and the second image sensor captures a second image of the at least one image and obtains a second image feature of the at least one image feature according to the second image, wherein an overlapping area, which is an area that the first sensing range overlapped with the second sensing range, defines the touch control area.

26. The electronic apparatus according to claim 25, wherein a distance between the first image sensor and the second image sensor is fixed, or the first image sensor and the second image sensor are on the same horizontal level.

27. The electronic apparatus according to claim 24, wherein the first image sensor comprises:
a base, which is composed of an optical isolation material, wherein a first accommodation room and a second accommodation room are formed in the base;
an infrared emitting unit, which is disposed in the first accommodation room, for emitting an outgoing infrared ray;
a first lens set having a first incidence surface and a first refraction surface, the first incidence surface is disposed at a side where the infrared emitting unit emits the outgoing infrared ray, wherein an illuminating range of the outgoing infrared ray is expanded after the outgoing infrared ray being refracted by the first refraction surface;
a second lens set having a second incidence surface and a second refraction surface, wherein the second incidence surface receives a reflective light reflected by the object, and the second refraction surface converges the reflective light;
an infrared filter having a first surface and a second surface, wherein the first surface faces the second refraction surface, and the reflective light is filtered through infrared filter to obtain an incoming infrared ray;
a sensing unit disposed in the second accommodation room, wherein a sensing surface of the sensing unit faces the second surface of the infrared filter to receive the incoming infrared ray, and the sensing unit integrates the received incoming infrared ray into the first image;
a register coupled with the sensing unit to register the first image; and
a pre-processing circuit coupled with the register to receive the first image for processing the first image to obtain and output the first image feature;
wherein, the infrared ray does not fall onto the second lens set, the infrared filter and the sensing unit directly,
wherein, the infrared filter is fixed on the base, coupled to the sensing surface of the sensing unit, or made by coating an infrared transmitting material on the second refraction surface of the second lens set.

28. The electronic apparatus according to claim 27, wherein the sensing unit, the register and the pre-processing circuit are disposed on a substrate, and the base, the infrared emitting unit and the substrate are disposed on a circuit board.

29. The electronic apparatus according to claim 19, further comprising a pico-projector, wherein the touched object is a 2D or 3D image projected onto the surface by the pico-projector.

30. A hand-wearing apparatus characterized in comprising:
a case;
an optical sensing module disposed at the case, wherein the optical sensing module defines a touch control area, detects a position information of an object in the touch control area, and comprises:
an image sensing module for defining the touch control area, capturing at least one image which comprises the object, and obtaining at least one image feature of the object according to the at least one image; and
a calculation module coupled with the image sensing module to calculate the position information of the object according to the at least one image feature; and
a control circuit coupled with the optical sensing module, and executing one of the at least one function input, which corresponds to the position information, to control the hand-wearing apparatus.

31. The hand-wearing apparatus according to claim 30, wherein the optical sensing module further comprises a communication module coupled with the calculation module and communicated with the control circuit.

32. The hand-wearing apparatus according to claim 30, further comprising an indication unit coupled with the control circuit to prompt the at least one function input to a user.

33. The hand-wearing apparatus according to claim 30, further comprising a pico-projector to project a touched object onto a human-body surface.

34. The hand-wearing apparatus according to claim 30, wherein the touched object is a 2D or 3D image.

35. The hand-wearing apparatus according to claim 30, wherein the position information comprises a coordinate and a moving trace of the object.

36. The hand-wearing apparatus according to claim 30, wherein the image sensing module comprises a first image sensor with a first sensing range, and the first image sensor captures a first image of the at least one image and obtains a first image feature of the at least one image feature according to the first image.

37. The hand-wearing apparatus according to claim 36, wherein the image sensing module further comprises a second image sensor with a second sensing range, and the second image sensor captures a second image of the at least one image and obtains a second image feature of the at least one image feature according to the second image, wherein an overlapping area, which is an area that the first sensing range overlapped with the second sensing range, defines the touch control area.

38. The hand-wearing apparatus according to claim 37, wherein a distance between the first image sensor and the second image sensor is fixed, or the first image sensor and the second image sensor are on the same horizontal level.

39. The hand-wearing apparatus according to claim 36, wherein the first image sensor comprises:
a base, which is composed of an optical isolation material, wherein a first accommodation room and a second accommodation room are formed in the base;
an infrared emitting unit, which is disposed in the first accommodation room, for emitting an outgoing infrared ray;
a first lens set having a first incidence surface and a first refraction surface, the first incidence surface is disposed at a side where the infrared emitting unit emits the outgoing infrared ray, wherein an illuminating range of the outgoing infrared ray is expanded after the outgoing infrared ray being refracted by the first refraction surface;
a second lens set having a second incidence surface and a second refraction surface, wherein the second incidence surface receives a reflective light reflected by the object reflecting the outgoing infrared ray, and the second refraction surface converges the reflective light;
an infrared filter having a first surface and a second surface, wherein the first surface faces the second refraction surface, and the reflective light is filtered through the infrared filter to obtain an incoming infrared ray;
a sensing unit disposed in the second accommodation room, wherein a sensing surface of the sensing unit faces the second surface of the infrared filter to receive the incoming infrared ray, and the sensing unit integrates the received incoming infrared ray into the first image;
a register coupled with the sensing unit to store the first image; and
a pre-processing circuit coupled with the register to receive the first image for processing the first image to obtain and output the first image feature;
wherein, the outgoing infrared ray does not fall onto the second lens set, the infrared filter and the sensing unit directly,
wherein, the infrared filter is fixed on the base, coupled to the sensing surface of the sensing unit, or made by coating an infrared transmitting material on the second refraction surface of the second lens set.

40. The hand-wearing apparatus according to claim 39, wherein the sensing unit, the register and the pre-processing circuit are disposed on a substrate, and the base, the infrared emitting unit and the substrate are disposed on a circuit board.

41. A control system characterized in comprising:
a control apparatus disposed on a surface, wherein the control apparatus comprises:
a touched object corresponding to at least one function input of the control apparatus;
an optical sensing module disposed on the surface, wherein the optical sensing module defines a touch control area, detects a position information of an object in the touch control area, and comprises:
an image sensing module for defining the touch control area, and obtaining an image feature of the object, wherein the touch control area covers the carrier; and
a calculation module coupled with the image sensing module to calculate the position information of the object according to the image feature;
a control circuit coupled with the optical sensing module, wherein the control circuit generates an operation signal corresponding to the position information while determining, according to the position information, that the object touches the touched object; and
a first signal interface coupled with the control circuit to receive the operation signal; and
a controlled apparatus being independent from the control apparatus and comprising a second signal interface coupled with the first signal interface to receive the operation signal from the first signal interface and performs an operation corresponding to the operation signal.

42. The control system according to claim 41, wherein the controlled apparatus is an electronic lock, an appliances or an electronic wall.
